(19) United States
(12) Patent Application Publication
(10) Pub. No.: US 2022/0186911 A1
(43) Pub. Date: Jun. 16, 2022

(54) Optical Device, Arrangement, Vehicle Lamp and Method

(71) Applicant: Osram Continental GmbH, Munich (DE)

(72) Inventors: Michael Koller, Hemau (DE); Richard Scheicher, Thierhaupten (DE); Thomas Huettmayer, Diedorf (DE); Christoph Koller, Nittendorf (DE); Julia Hoffmann, Regensburg (DE); Christian Gammer, Traitsching (DE); Sergey Khrushchev, Regensburg (DE)

(21) Appl. No.: 17/439,753

(22) PCT Filed: Mar. 16, 2020
(86) PCT No.: PCT/DE2020/100203

§ 371 Date: Sep. 15, 2021

(30) Foreign Application Priority Data
Mar. 15, 2019 (DE) 10 2019 106 686.7
May 13, 2019 (DE) 10 2019 112 474.3

(51) Int. Cl. F21V 11/08; F21V 29/70

(52) U.S. Cl. CPC F21V 11/08; F21V 29/70

(57) ABSTRACT

An optical device comprising at least one lamp is disclosed. The lamp comprises an output face for the light, and an image mask is mounted on said output face.

### CROSS REFERENCE TO RELATED APPLICATION

This application is a U.S. National Stage entry under 35 U.S.C. § 371 based on International Application No. PCT/DE2020/100203, filed on Mar. 16, 2020, which was published under PCT Article 21(2) and which claims priority to German Application No. 102019106686.7, filed on Mar. 15, 2019 and to German Application No. 102019112474.3, filed on May 13, 2019. The disclosure of each of the foregoing documents is incorporated herein by reference.

### TECHNICAL FIELD

The invention relates to an optical device comprising at least one lamp, an arrangement comprising said optical device, a vehicle lamp comprising the optical device, and a method for manufacturing the optical device.

### BACKGROUND

From the state of the art, projection systems are known in automotive industry that are installed instead of a door exit illumination. The projection systems may, for instance, project a brand name and/or a symbol onto the ground next to the door as soon as the door is opened. The projection systems consist normally of an LED (light emitting diode) whose light irradiates into illumination optics, which bundles the light of the light source so that a uniform illumination results. A transparent picture, e.g., a Graphical Optical Blackout (GOBO) or a diapositive is then arranged downstream of the illumination optics, and further optics, especially imaging optics, for instance, for enlarging the projection, may be arranged downstream of said transparent picture. The dimensions of this projection system usually have a length of 25 mm and a diameter of 10 mm.

It is an object of the present invention to provide a compact optical device that is cost-efficient and simple with respect to the technology of the device and by means of which picture information is projectable. It is another object to provide an arrangement comprising the optical device. Moreover, a vehicle lamp comprising the optical device is to be provided, and a method for manufacturing the optical device.

### SUMMARY

The object with respect to the optical device is solved by the features of the claims. In accordance with the invention, an optical device comprising at least one light source and/or one light source with a downstream converter is provided. The light source or light source with converter may, for instance, be an LED (light emitting diode). The light source or the light source with converter comprises in particular an output face for the light which may, for instance, be an output face on the converter and/or an output face on the light source. Furthermore, an image mask, for instance, a Graphical Optical Blackout (GOBO), or a diapositive, is arranged on the output face of the light source and/or of the converter and/or the input face of the converter.

It is an advantage of this invention that, by means of the optical device, a projection corresponding to the image mask is projectable, and that the optical device is at the same time of very compact design. Specifically, for instance, illumination optics may be omitted between the light source and the GOBO, for instance, because it is not necessary due to the direct mounting of the image mask on the output face of the light source or the light source with converter. The result of this is that the optical device may be particularly small and can additionally be manufactured in a particularly cost-efficient manner because an assembly of the optical device is thus also more cost-efficient than it is with illumination optics. Another advantage is that also the complexity of the system may be reduced to a minimum. In other words, by means of the optical device it is possible to project, for instance, a symbol and/or some other picture that is imaged on the image mask, especially in the negative image, wherein the optical device is formed only of two or three elements, the light source or the light source with converter as well as the image mask arranged thereon. This is additionally advantageous since the optical device is thus less susceptible to damages because few components are used. In the case of a conventional projection system, for instance, the illumination optics may be displaced or even destroyed by vibrations or by shocks, for instance, if the projection system is arranged in a moving vehicle, or if the projection system is mounted in a door, for instance, especially in a pivotable vehicle door. Because the optical device does not comprise sensitive illumination optics, this may be excluded. Furthermore, the optical device may be arranged in the exterior of a vehicle, for instance, the door, or else in the interior, and thus the optical device may perform a projection, for instance, of the open trunk lid onto the inner floor of the loading area or into the passenger compartment. In other words, the optical device may be used in various ways.

The image mask is preferably formed as a layer on the output face of the light source and/or of the converter, and/or the input face of the converter. The image mask may, for instance, be connected in a form-fit and/or a force-fit and/or a substance-to-substance manner with the light source and/or the converter. The image mask may, for instance, be connected with the light source and/or the converter via, for example layered, a fastener, for instance, glued. The fastener, for instance, glue, may be applied on the output face of the converter and/or the light source and/or the input face of the converter. The image mask may subsequently be positioned at or on the fastener. After the hardening or the mounting of the image mask at the fastener the image mask is connected as a layer with the converter and/or the light source. It is also possible that the fastener is applied or placed on the image mask. It is also possible that the fastener forms a further layer between the light source or the converter and the image mask, which is formed as a layer.

In one embodiment the image mask may be a GOBO (graphical optical blackout) or a diapositive, and it may be applied as a layer on the light source and/or the converter.

In another embodiment the image mask may be a layer of a material, for instance, of metal, which is formed on the light source and/or the converter.

In particular, the light source is formed as an LED, and the image mask may especially be formed as a layer on the output face of the LED. The light source which is especially an LED has preferably a plane or flat output face on which the image mask is applied as a layer. The output face may, for instance, have a square or a rectangular or a round shape. The image mask may have approximately the same size as the output face of the light source. In particular, the image mask as a layer may cover the plane or flat output face of the light source completely.

If the light source with converter is a laser light source with a converter, especially in correspondence with the OSRAM LARP (Laser Activated Remote Phosphor) technology, it may be partially and/or fully converting, so that the light color of the emitted light may have different colors depending on which converter is used and/or depending on which share of the primary light is converted into conversion light (LARP technology). The choice of the converter may, for instance, also depend on the use requirements, so that yellow converting ceramic converters are, for instance, usable for a picture-projecting direction indicator. As an example, an Osram Oslon Compact CL-LCY CEUP may be used for an LED with a yellow converting ceramic converter without color mixing of the excitation light which may, for instance, be used as a direction indicator. In other words, the converter and/or the resulting conversion light is/are not specified to white and partially or fully converting elements, such as for instance, for red and/or green and/or yellow, may be used.

The converter comprises a luminescent substance as a conversion material, wherein the “luminescent substance” may also be a luminescent substance mixture of a plurality of individual luminescent substances. A preferred individual luminescent substance may be cerium-doped yttrium aluminum garnet (YAG:Ce), then with a yellow light as a conversion radiation. In general, however, another and/or other individual luminescent substance(s) is/are also possible alternatively or additionally, for instance, for the emission of red and/or green conversion light, wherein another yellow luminescent substance is also conceivable.

Furthermore, the optical device may comprise at least one optical element, for instance, imaging optics, which follows, in particular in the optical path of the light, the light source or the light source with converter, i.e., is positioned downstream of the light source or the light source with converter. Due to the small area to be imaged, i.e., due to the fact that the image mask is arranged directly on the output face of the light source and/or the converter and/or the input face of the converter, the optical element may be designed in a very simple and/or very compact manner. Due to the optical element it is, for instance, possible to enlarge and/or sharpen the projection picture and to increase the efficiency of the optical device since thus an optimum luminous efficacy of the optical device is possible, i.e., the projection may be particularly bright and/or clear. Furthermore, projection optics may design the projection picture visually, for instance, stretch it or image it asymmetrically.

In one embodiment, the image mask may be at least partially or completely of a metal, for instance, of palladium, and/or titanium, and/or gold, and/or aluminum, and/or copper. This is advantageous because the metal may be applied easily and/or in a cost-efficient manner, and additionally and/or alternatively the metal may be removed in a cost-efficient and simple manner by means of an etching technology and/or by laser ablation, so that the image mask is produced. In summary, it is particularly cost-efficient to design the image mask of metal, also because the processing and/or the manufacturing of the optical device is very cost-efficient due to this fact. Furthermore, an image mask of metal design is stable to environmental influences as well as to temperature fluctuations.

It is, however, also conceivable to use a mask of other materials or material compositions, for instance, glass, coated or doped glass, plastics as well as electrochromic materials. The characteristics of electrochromic materials may be changed by current flow.

In a further embodiment, a coating technology may be used, in particular if the image mask mounted on a converter is of a metal, which enables a condition of the converter to be monitored, especially the converter with a laser light source. If the converter is damaged and/or if it breaks and thus also damages the metal image mask, the laser light source may be switched off. Because the image mask is metal, an operating current for the light source may, for instance, be conducted through the image mask and/or through parts of the image masks, and in the case of an interrupted current flow and/or in the case of a changed resistance produced by a damage to the converter and/or the image mask it may be detected (indirectly) that the converter is defective and the laser light source may be switched off or at least be reduced in intensity. This is advantageous because the light of the laser light source may, for instance, be harmful to the human eye. In other words, the image mask of metal may additionally fulfill a monitoring task, and thus an additional component fulfilling this task is obsolete. Consequently, manufacturing costs may be saved, and additionally the structure of the optical device that comprises in particular a laser light source, which is preferably monitored for safety reasons, is thus less complex.

Furthermore, it is advantageous if the image mask comprises at least two regions of different thickness, wherein these regions have different translucence and thus absorption of the primary light. In other words, the material of the image mask may partially be removed with different intensity if the image mask is manufactured by coating and subsequent partial removing of the coating. If the image mask is, for instance, made of metal, especially of aluminum, a region that is not intended to be lightproof may have a thickness of 150 nanometers, and a region that is intended to be somewhat translucent may, for instance, have a thickness of smaller than/equal to 40 nanometers. This is advantageous because a light picture, i.e., the projection, of the optical device may thus be designed more flexibly than with an image mask, for instance, where different brightness in the light picture is excluded, i.e., an image mask which merely has light-proof and completely translucent regions. In particular, the thickness of the image mask may be varied continuously, so that continuous brightness values may be adjusted in the light picture. This is of advantage because a light picture comprising more than two regions and/or brightness values may thus be produced without the additional use of additional image masks or layers on the light source or the light source with converter. Thus, the optical device has a variety of possible applications, for instance, for advertising purposes.

In a further embodiment the image mask may comprise additionally and/or alternatively regions of different structure so that the light picture of the optical device includes regions of different brightness. In a first embodiment, the image mask includes at least two regions, wherein both regions comprise recesses. The recesses in the first region may, for instance, have a different arrangement and/or size and/or shape than the recesses in the second region. Due to the different design and/or arrangement of the recesses, the brightness of the light picture may differ in the regions. In a first example, especially the size of the recesses, which are, for instance, points, is changed, and the arrangement of the recesses is maintained uniformly across the entire image mask. In other words, recesses of different size are arranged in a regular, consistent pattern, wherein recesses arranged side by side differ only slightly, especially in size and/or are of equal size. If the image mask is produced using laser ablation, the amplitude is changed during processing in the above-described embodiment so that recesses of different size are produced. The frequency is, however, maintained, so that the recesses are arranged in a consistent pattern. In a second embodiment, however, the frequency may be changed during processing by means of laser ablation and the amplitude may be maintained so that the grid in which the recesses are arranged may change across the image mask. In other words, the image mask includes at least two different regions, wherein they each comprise recesses of equal size, however, which have a different distance from each other.

Moreover, it is advantageous if the image mask is designed of one or a plurality of color screens. The image mask may be designed layer-wise so that it may include, for instance, color screens with a plurality of colors, for instance, red, green, and blue, and as a further layer also a light-proof metal layer. Thus, colored projections and/or light pictures may also be implemented. The image mask may, for instance, be formed of a red color screen and/or a green color screen and/or a blue color screen, wherein arbitrary mixed colors are possible, especially by the combination of these three primary colors. The color screens are preferably arranged in layers, especially sandwich-like, at the output face of the light source and/or the converter and/or at the input face of the converter. Due to the different color screens, it is possible to project many different motifs by the optical device, and thus the design is very flexible.

It is also conceivable to construct the converter with a plurality of layers, wherein a respective layer converts the light differently in each case, so that the respective resulting radiation comprises a different light color. If the converter is, for instance, built of a multi-layer ceramic, it is possible first of all to produce it over the full area and then again to remove the different ceramic layers selectively, so that ceramic layers with different shapes are produced, and the light picture may have different colors. The processing may, for instance, be performed with a laser, especially an ultrashort pulse laser.

If the image mask, which may be formed of at least one color screen and/or one light-proof layer, so that it comprises at least two layers, is structured by means of etching and/or laser ablation, it may additionally be advantageous to apply, at least between the individual color screens and/or the light-proof layer, an insulating layer, such as a silicon dioxide layer, during the etching process. This means, first a layer, especially the layer arranged directly on the converter and/or the light source, is exposed, for instance, by an etching process and/or laser ablation. Subsequently, an insulating layer is applied on the layer already processed before a color screen and/or a light-proof layer is applied. This one may then also be exposed, and due to the insulating layer it may be avoided that the layer directly arranged on the converter and/or the light source is damaged during processing. If further layers are applied, it is also useful to arrange an insulating layer between each of or at least between a part of the further layers.

The insulation layer may additionally be structured on demand so as to generate, for instance, light dispersing and/or refractive aspects and thus influence the optical effect. Thus, further effects may be generated in the light picture of the optical device.

In one embodiment, the image mask may be conductive and/or contacted electrically such that, in the case of a defect of the image mask, the resistance changes or the current flow is interrupted. Alternatively or additionally, the image mask may be conductive and/or contacted electrically such that the light source can be supplied with energy.

In a further embodiment, the image mask may be conductive. This is particularly advantageous if the light source is a directly emitting LED because the image mask, which consists preferably of metal, may thus be used for current distribution and/or for the current supply of the LED. Furthermore, the design of the image mask may then be adapted to the function of the current distribution, i.e., be adapted to this purpose. Another advantage of this is that further costs and further components can be saved. Furthermore, as already described before, the image mask may, for instance, fulfill a monitoring task if it is contacted electrically, e.g., a safety shutdown for laser light sources. An advantage of this is that further components may be saved.

Alternatively and/or additionally, the image mask, which is preferably formed as a metal layer, may be used as a temperature sensor, so that the light source or the light source with converter may be switched off in the case of overheating. It is moreover possible that the metal layer which may be used as a temperature sensor does not influence the light of the light source, but is only used as a temperature sensor.

Furthermore, a heat conductor may be arranged at the image mask, i.e., the heat conductor may, for instance, have a similar shape as the image mask so that the heat conductor does not project over the image mask and so that the projected light picture still corresponds to a negative image of the image mask. This is particularly advantageous if the image mask is made of metal because it is adapted to easily transfer the heat generated in particular in the light source or the converter to the heat conductor. Due to the heat conductor, it is possible to use a light source or a light source with converters, which have a higher performance and hence a higher thermal output, and therefore the projection of the optical device may be brighter and clearer. Moreover, a more compact optical device may thus be produced that can be mounted in a smaller installation space because a smaller light source may thereby have higher performance. It is, for instance, possible to integrate the optical device into a smartphone and/or a telephone. The optical device may, for instance, be used to project a light picture once somebody calls. If the optical device is used in a smartphone, it may, for instance, be used to produce various effects if photographs are taken with the smartphone. For this purpose, the optical device may project a symbol and/or a pattern on the area to be photographed.

Furthermore, the optical device may include a plurality, i.e. at least two, of light sources or light sources with converters. Thus, for instance, different effects may be produced, e.g., when opening and closing a car door if the optical device is used in a vehicle. When opening the door, for instance, both light sources or light sources with converters may be switched on and thus generate a brighter projection than, for instance, during closing, wherein during the closing of the car door, for instance, only one light source or light source with converter may be switched on. The light sources or light sources with converters may additionally emit different colors, and so, when opening the door, a green symbol might, for instance, appear, and when closing a red one. This may, for instance, be used in the case of an electrically closing tailgate of a vehicle and/or, for instance, in vehicles of the local passenger traffic.

Furthermore, at least two optical devices may be arranged side by side and/or in series, so that different projections may be projected in different situations, and/or a larger and/or brighter light picture may be produced altogether.

It is also possible that a plurality of optical devices is provided and is, for instance, arranged side by side, for instance, in the form of an array, wherein an image mask may be assigned to each light source or light source with converter. The optical devices may, for instance, be arranged in rhombus shape, and/or in oval shape, and/or side by side, and or in a rectangle. The image masks of the individual light sources or light sources with converters may not differ, and/or differ only slightly, and/or partially, and/or substantially completely. Optical devices may, for instance, comprise the same image mask so as to represent the light picture of the optical devices particularly brightly and sharply, for instance, also when the projection plane comprises irregularities. For this purpose, for instance, the optical elements of the different optical devices, which comprise the same image mask, may be of different design. With this arrangement it is also possible to produce an animation in that the light sources or the light sources with converters of the respective optical devices are switched on or off sequentially, so that an animation may be produced. For this purpose, the image masks of the optical device may differ only slightly, for instance, and thus a continuous animation may be produced.

It is also possible, if at least two optical devices form an arrangement, for the image masks of the optical devices to differ from each other, but to project a light picture together. The optical devices may, for instance, include light sources that project different light colors so that the light picture includes different colors. The image masks are, for instance, designed such that the projected light of the optical devices will not overlap, so that the different colors are sharply separated from each other. In a further embodiment, however, it is also possible for the projected light pictures to overlap so that color gradients are produced and/or the light picture includes at least three different colors, wherein the third color may be a mixed color of the light colors emitted by the light sources.

Furthermore, the optical device is preferably arranged in a vehicle lamp. The optical device may, for instance, be installed in a direction indicator of a vehicle, in particular in addition to a usual direction indicator so that a projection of the direction indicator onto the road may take place for vehicles driving in the opposite direction and/or following, so as to increase the attention of other drivers. It is also possible to arrange two optical devices in the direction indicator. Thus, an animation may be generated in that the light sources or light sources with converters of the optical device are switched on and off alternatingly and/or continuously.

In a method for manufacturing, preferably in a first step, the optical device, the output face of the light source and/or of the converter, and/or the input face of the converter is coated with a material, especially a metal. This may take place in particular over the full area, i.e., the entire output face may be coated with the material. But it is also possible that only a part of the output face is coated. In a second step, the material that was applied on the output face before is then partially removed so that the image mask is formed. In other words, the desired picture content may, for instance, be exposed by etching and/or by laser ablation. Due to this method, it is possible to produce an image mask on the output face of the light source and/or of the converter, and/or on the input face of the converter in a simple and cost-efficient manner. Furthermore, both techniques offer large design freedom so that any shapes can be etched into the image mask or be produced by laser ablation. Additionally, the manufacturing method is suited for manufacturing the optical device in large-scale and/or mass production. If laser ablation is used, this is additionally advantageous because arbitrary shapes may be represented in the image mask, and they may be different in the manufacturing of each image mask. In other words, by means of laser ablation the image mask is easy to personalize and/or to produce cost-efficiently in a small quantity per motif on the image mask.

If the optical device comprises a light source with converter, and if the image mask is arranged on the converter, especially on the input and/or output face, the coating of the converter with a material from which the image mask is manufactured, and alternatively or additionally the exposing by etching or laser ablation may be performed before the converter is arranged at the light source. This means that the converter may be mounted at the light source only after the image mask is applied.

If the image mask is of aluminum, an image mask may, for instance, be produced in that the output face of the light source and/or of the converter, and/or the input face of the converter is coated in a first step with aluminum of a layer thickness of approximately 150 nanometers, for instance. Subsequently, the aluminum is removed by means of laser ablation. In this process, for instance, the laser energy per pulse, i.e., the single pulse energy, may be approximately 3 microjoule, and the pulse frequency of the laser approximately 50 kHz. The laser pulse length may, for instance, be approximately 20 ps. The structural width, i.e., the distance with which the laser may expose the aluminum, may be approximately ten microns in this configuration. Depending on the application or the material these values may be modified.

Furthermore, in the case of laser ablation the amplitude and/or the frequency may be modulated. In the case of amplitude modulation, points of different size may be exposed in a fixed grid so as to achieve varying translucence in different regions. In the case of frequency modulation, however, with a fixed point size differently fine grids of exposed points are generated, with the similar result that different regions have varying translucence.

Both in the case of laser ablation and in the case of etching of the image mask, i.e., in the case of exposing of the image mask, it may be achieved by selecting suitable parameters that the material is not completely removed in some regions so that the previously applied material has different thickness. This may also produce regions with varying translucence.

In a further step, which is especially performed prior to the applying of the material on the output face, dichromatic layers, i.e., the color screens, may be applied on the output face, and subsequently be processed, for instance, by laser ablation or etching technology so that it is possible to produce colorful photographic images.

The light source or light source with converter of the optical device may be designed as a light emitting diode (LED), and/or as an organic LED (OLED), and/or as a laser diode, and/or as an illuminant operating pursuant to a Laser Activated Remote Phosphor (LARP) principle, and/or as a halogen lamp, and/or as a gas discharge lamp (High Intensity Discharge (HID)), and/or in connection with a projector operating pursuant to a Digital Light Processing (DLP) principle. Thus, a variety of alternatives is available as a light source or light source with converter for the illumination device in accordance with the invention.

The optical element or a respective optical element is chosen from a group, wherein the group includes, for instance, a lens, a micro lens array, a reflector, a diaphragm, a light guide, a holographic element, a Liquid Crystal Display (LCD), Digital Mirror Device (DMD), and/or a converter with a luminescent substance. The optical element, for instance, may additionally be a standard lens and/or a standard element, for instance, an element from photography and/or an objective lens of a smartphone camera. A C-mount camera objective lens system with a sensor may, for instance, be used if the sensor is used for sharpness adjustment, for instance. Especially if the light source and/or the light source with converter and/or the arrangement with at least two optical devices is smaller than the image field of the sensor, a sharp projection over the full area may thus be possible. If an individual light source or light source with converter is used, also objective lenses for smartphone cameras may be used because a high-value light picture can thus also be produced with small image sensors, and the optical device additionally has a very compact installation space. Due to the use of standard elements, the manufacturing costs of the optical device are particularly low.

The vehicle may be an aircraft or a water-based vehicle or a land-based vehicle. The land-based vehicle may be a motor vehicle or a rail vehicle or a bicycle. It is particularly preferred that the vehicle is a truck or a passenger car or a motorcycle. The vehicle may further be designed as a non-autonomous or a part-autonomous or an autonomous vehicle.

An optical device comprising at least one lamp is disclosed. The lamp comprises an output face for the light, and an image mask is mounted on said output face.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic structure of the optical device in accordance with an embodiment.

FIG. 2 is a size comparison of the optical device with an object.

FIG. 3 is a top view of a lamp with an image mask in accordance with a further embodiment.

FIG. 4 is a schematic representation of an image mask with a structure.

FIG. 5 is an image mask that was processed with laser ablation in accordance with two different embodiments.

FIG. 6 is a schematic structure of an optical device in accordance with a further embodiment.

FIG. 7A is a schematic view of an optical device in accordance with another embodiment.

FIG. 7B is a schematic view of an optical device in accordance with yet another embodiment.

FIG. 8 is an arrangement with optical devices in accordance with an embodiment.

FIG. 9 is a schematic structure of an arrangement with optical devices in accordance with a further embodiment.

### DETAILED DESCRIPTION

Reference will now be made in detail to some embodiments of the invention, examples of which are illustrated in the accompanying drawings.

FIG. 1 illustrates an optical device 1 comprising a light source 2, such as for instance, an LED. Furthermore, the optical device 1 includes a converter 4 that is positioned downstream of the light source 2 and is disposed on the light source 2. An image mask 10 is mounted on the converter 4. The image mask 10 is directly mounted on the converter 4 without a further carrier material. Furthermore, the optical device 1 comprises an optical element 12 that is preferably imaging optics so that the projection of the optical device is sharper and/or more efficient.

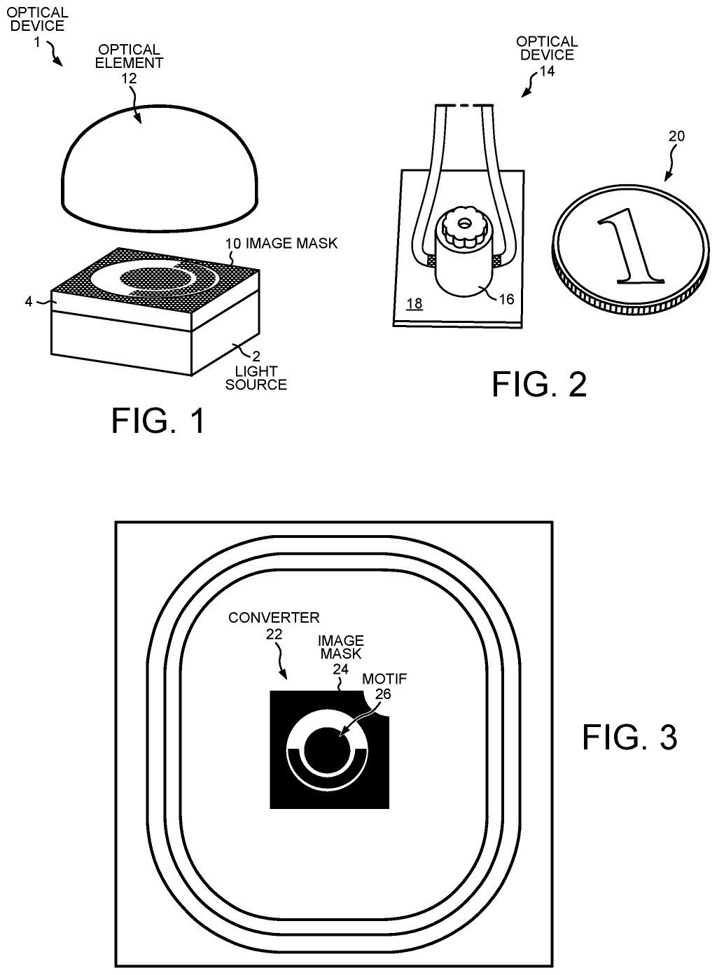

FIG. 2 illustrates an optical device 14 comprising an optical element 16 that covers, in this illustration, both the light source and the image mask. (See FIG. 1) The optical element 16 is arranged on a circuit board 18. Next to the optical device 14 a eurocent 20 is positioned, demonstrating that the optical device 14 is very compact and thus requires only a small installation space.

FIG. 3 illustrates a converter 22 on which an image mask 24 is mounted. The image mask 24 is mounted such that a motif 26 is generated, wherein the projection produced by the image mask 24 shows the negative logo.

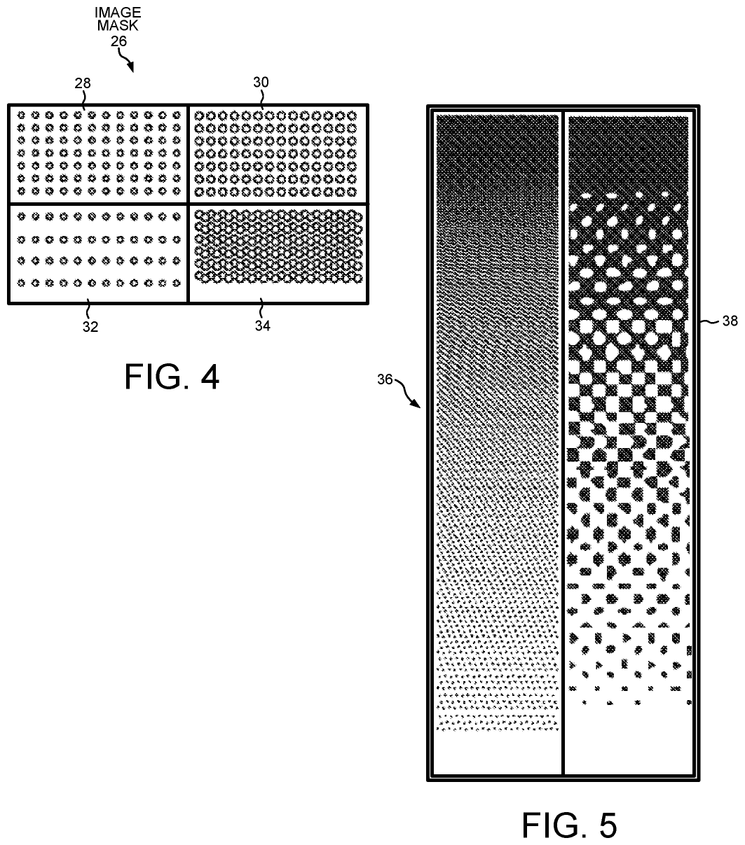

FIG. 4 illustrates an image mask 26 in a schematic structure, wherein it is divided into four different regions 28, 30, 32, 34. In a first region 28, the image mask 26 includes exposed point recesses, i.e., translucent points that are distributed evenly in the region 28 such that they always have the same distance from each other.

In the region 30, the image mask 26 also includes exposed point recesses, wherein they have the same distance as in region 28, but have a larger diameter. This means that the light picture that may be generated by this region is somewhat brighter than the light picture of the region 28.

In the region 32, the point recesses are arranged at a regular distance from each other, wherein in a respective direction the point recesses have the same distance, wherein the distance in one direction is larger than in another direction. Additionally, they have approximately the same size as the point recesses in the region 28.

In the region 34 of the image mask 26, the point recesses are spaced apart by different distances in different directions, wherein the point recesses in one direction have no distance from each other and are partially overlapping, and the points in the other direction have a distance from each other and are not overlapping. Thus, rows with overlapping point recesses are produced, wherein the rows are evenly spaced from each other. Additionally, the distance of the rows with overlapping point recesses is the smallest in the region 34.

The different regions 28, 30, 32, 34 appear in the projection with different brightnesses when the image mask is penetrated by radiation. The larger the density of points and/or the larger the points, the brighter the region 28, 30, 32, 34 of the image mask 26 appears. The region 34 is the brightest, and the region 32 is the darkest.

FIG. 5 illustrates two different image masks 36 and 38, wherein they have different structures. Both image masks 36, 38 are generated by means of laser ablation, wherein in the case of the mask 36, the frequency was modulated during manufacturing, i.e., a differently fine grid of point recesses which are translucent was produced with a fixed point size. The point recesses in image mask 36 become increasingly narrow from one side to a second side, wherein they overlap at the second side and hence the image mask is almost completely translucent in the second region.

In image mask 38, to the contrary, the amplitude was modulated during processing so that differently large point recesses are produced in a constant grid. This means that the point recesses have the same distance from each other across the entire image mask 38, but the size of the point recesses is varied. From a first side to a second side of the image mask 38, the point recesses become increasingly larger. At the first side, the point recesses are of rather small dimension while at the second side they are so large that they overlap at least partially or even completely. In both image masks, the brightness is changed continuously and/or successively so that a light picture may be designed flexibly.

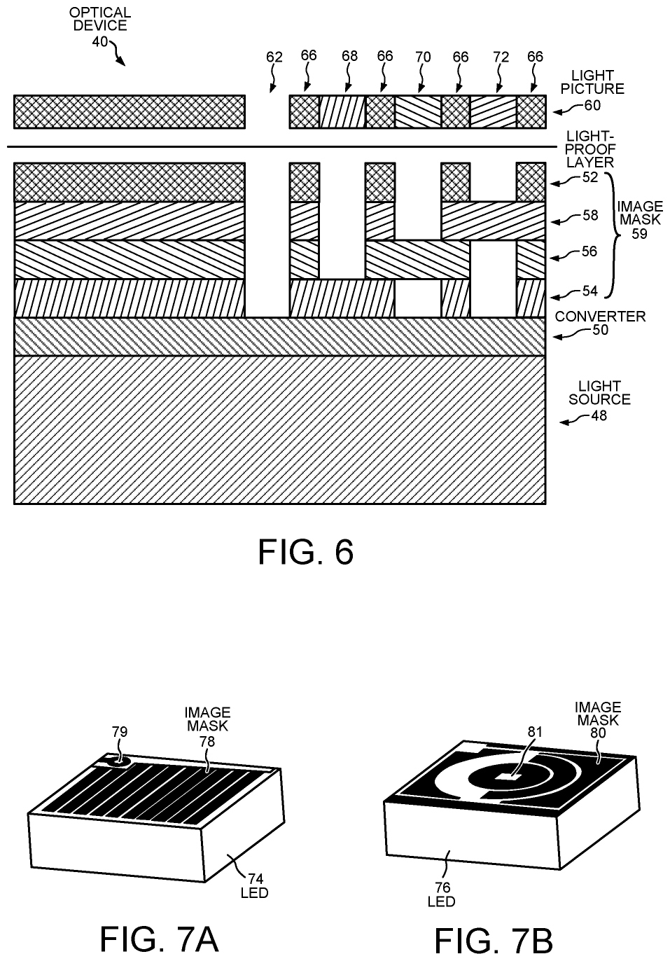

FIG. 6 illustrates an optical device 40 comprising a light source 48, a converter 50, and a light-proof layer 52. Various color screens 54, 56, 58 are arranged between the converter 50 and the light-proof layer 52, wherein they may, for instance, have the colors red, green, and blue. The color screens 54, 56, 58 and the light-proof layer 52 form an image mask 59. Furthermore, the converter 50 is adapted to convert the light of the light source 48 into white light. This is advantageous because the colors of the color screens 54, 56, 58 are, for instance, better to mix, and thus, for instance from a blue and a yellow color screen, a green region may be represented in a light produced picture.

Furthermore, a resulting light picture 60 is illustrated schematically in FIG. 6. It is produced when the light source 48 is switched on. In this example, the color screens 54, 56, 58 are structured such that, in a first section 62 of the light picture 60, no color screen 54, 56, 58 is provided between the converter and an output face for the light of the optical device 46. This means that an observer perceives the section 62 of a light picture 60 as white. A section 66 following the section 62 will be observed as black and/or as not being illuminated by an observer of the light picture 60 because the light of the light source 48 is shielded by the light-proof layer 52. Below the light-proof layer 52, the color screens 54, 46, 58 are still formed in this region. There is also the possibility that the color screens 54, 46, 58 are exposed in this region. The light picture 60 would nevertheless show the same. In a section 68 that follows the section 66, the observer will perceive the color of the color screen 54. This section 68 is followed in this embodiment by a further section 66 that is perceived as black, and which is followed by a section 70 that has the color of the color screen 56 in the light picture 60. It is moreover followed by a further section 66, which is followed by a section 72 that has the color of the color screen 58. Finally, a further section 66 follows the section 72.

FIG. 7A and FIG. 7B each illustrate an embodiment of an optical device with a respective directly emitting LED 74 and 76 as a light source. On the LED 74 an image mask 78 is arranged that is designed to be conductive. Furthermore, it includes a contacting place 79 at which, for instance, a current source may be connected so as to supply the LED 74 with electrical energy. Furthermore, the image mask 78 is designed such that it projects a regular strip pattern when penetrated by radiation from the LED 74. On the LED 76, an image mask 80 is arranged that is also conductive and is adapted to supply the directly emitting LED 76 with current. The image mask 80 shows a logo.

Additionally, a heat conductor 81 may be arranged on the image mask 80. It is preferably designed such that it does not cover the logo of the image mask 80. In this example, the heat conductor 81 may, for instance, cover a light-proof region of the image mask 80. The heat conductor 81 may dissipate heat that, for instance, is emitted by the LED 76.

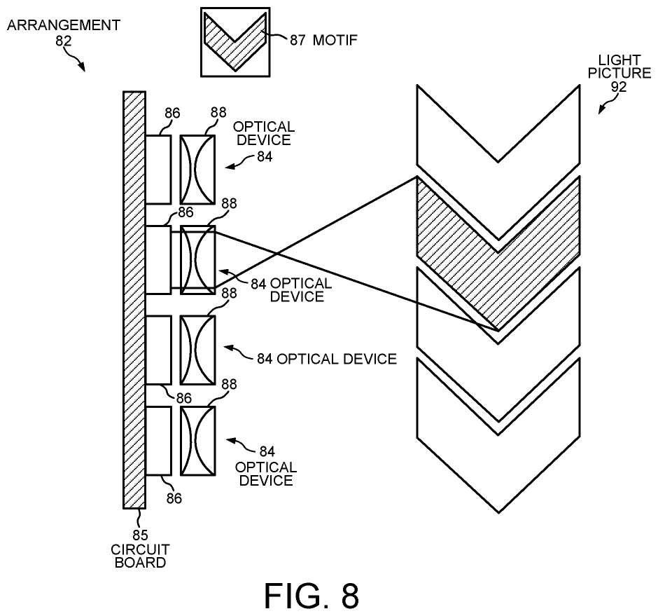

FIG. 8 illustrates an arrangement 82 that includes four identical optical devices 84 which are arranged on a joint circuit board 85. Each of these optical devices 84 comprises a respective light source, not illustrated here, with a respective converter 86. On the output face of the converter or the light source 86 or on the input face of the converter, a respective image mask is arranged which is not shown in this illustration and which comprises the motif 87 that is illustrated separately. Moreover, each optical device 84 includes an optical element 88 that, in this example, is a dispersing lens or biconcave lens. The four optical devices 84 produce a light picture 92, wherein the optical elements enlarge the light picture 92. The light picture 92 shows four times the motif 87 of the image mask, which is provided in each of the optical devices 84, wherein they are illustrated one below the other in the light picture 92. The arrangement 82 may, for instance, be used in a vehicle as an additional direction indicator, wherein the light picture 92 is, for instance, visible in front of and/or behind of a car when the driver actuates a direction indicator control. If the optical devices 84 are switched on and off consecutively, a kind of animation may moreover be produced.

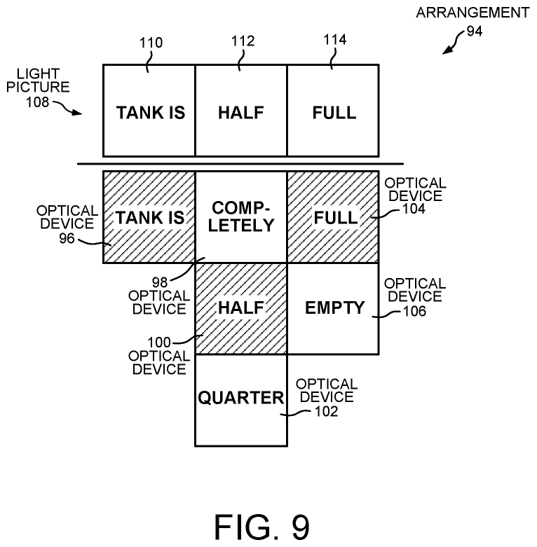

FIG. 9 illustrates a further example of an arrangement 94 that includes six optical devices 96, 98, 100, 102, 104, 106, wherein an optical element is not shown here. The arrangement 94 may, for instance, be used to inform a driver in a vehicle about the approximate status of the tank level. For this purpose, a respective optical device 96, 98, 100, 102, 104, 106 comprises a different motif. The motif of the image mask of the optical device 96 illustrates in a first section 110 of a light picture 108 “tank is” when a light source of the optical device 96 is switched on. The light picture 108 is illustrated, for the sake of convenience, directly next to the optical devices 96, 98, 100, 102, 104, 106.

The optical devices 98, 100, 102 show different motifs. The optical device 98 projects the motif “completely”, the optical device 100 projects “half”, and the optical device 102 projects “quarter”. The projection of the optical devices 98, 100, 102 is always projected to the same position in a section 112 of the photographic image 108. In other words, preferably only one of the light sources of the optical devices 98, 100, 102 is switched on. If they are all switched on, the motifs of the three optical devices 98, 100, 102 are illustrated simultaneously in section 112 of the light picture. In order to prevent this, the optical devices 96, 98, 100, 102, 104, 106 may, for instance, be connectable with an intelligent current control that is adapted to control which light sources are switched on, so that preferably maximally one of the light sources of the optical devices 98, 100, 102 is switched on. The optical devices 98, 100, 102 are preferably arranged side by side, wherein a respective imaging optics, not illustrated here, of the respective optical devices 98, 100, 102 may be designed such that the optical devices 98, 100, 102 always project their respective light picture into the section 112.

Also the optical devices 104, 106 are preferably arranged side by side such that the optical device 104 projects the motif “full” and the optical device 106 projects the motif “empty”. The optical devices 104, 106 are, like the optical devices 98, 100, 102, designed such that they project into the same section 114. This means that the optical devices 104, 106 project their respective light picture onto the same position, the section 114 of the light picture 108.

In FIG. 9 the light sources of the optical devices 96, 100, and 104 are switched on so that the light picture 108 indicates “tank is half full”. If, instead of the light source of the optical device 100, the light source of the optical device 98 were switched on, the light picture 108 would indicate “tank is completely full”. The motifs “half” and “completely” are indicated in the same section 112.

### REFERENCE NUMERALS

| | |
|---|---|
| optical device | 1, 14, 46, 84, 96-106 |
| light source | 2, 48, 74, 76 |
| converter | 4, 22, 50, 86 |
| image mask | 10, 24, 36, 38, 59, 78, 80 |
| motif | 26, 87 |
| optical element | 12, 16, 88 |
| circuit board | 18, 85 |
| cent | 20 |
| region of an image mask | 28-34 |
| light-proof layer | 52 |
| color screen | 54-58 |
| section | 62, 66, 68, 70, 72, 110-114 |
| light picture | 60, 92, 108 |
| directly emitting LED | 74, 76 |
| contacting place | 79 |
| heat conductor | 81 |
| arrangement | 82, 94 |

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-14. (canceled)

15. An optical device, comprising:
a light source having an output surface;
a downstream converter having an input face and an output face; and
an image mask disposed adjacent to the output face, wherein the image mask is configured such that picture information is projected as light is emitted by the light source from the output surface, through the downstream converter and through the image mask.

16. The optical device of claim 15, further comprising:
an optical element disposed downstream of the light source and through which light emitted by the light source passes.

17. The optical device of claim 15, wherein the image mask is at least partially made of metal.

18. The optical device of claim 15, wherein the image mask includes at least two regions of different thickness and thereby different translucence causing a light picture projected by the optical device to have regions of different brightness.

19. The optical device of claim 15, wherein the image mask includes at least two regions having differently arranged holes and thereby different translucence causing a light picture projected by the optical device to have regions of different brightness.

20. The optical device of claim 15, wherein the image mask is formed as a screen.

21. The optical device of claim 15, wherein the image mask is electrically conductive such that a defect in the image mask can be detected by a change in resistance of the image mask.

22. The optical device of claim 15, wherein the image mask is electrically conductive such that the light source is supplied with energy through the image mask.

23. The optical device of claim 15, further comprising:
a heat conductor disposed adjacent to the image mask.

24. The optical device of claim 15, further comprising:
a second light source; and
a circuit board, wherein the light source and the second light source are both connected to the circuit board.

25. The optical device of claim 15, wherein the downstream converter converts the light emitted by the light source into white light.

26. The optical device of claim 15, wherein the optical device is part of a vehicle lamp.

27. The optical device of claim 15, wherein the optical device is included in an optical arrangement that includes a second optical device.

28. An optical device, comprising:
a light source having an output surface;
a downstream converter having an input face and an output face; and
an image mask disposed between the output surface and the input face, wherein the image mask is configured such that picture information is projected as light is emitted by the light source from the output surface, through the image mask, and through the downstream converter.

29. The optical device of claim 28, further comprising:
an optical element disposed downstream of the downstream converter and through which light emitted by the light source passes.

30. The optical device of claim 28, wherein the image mask includes a first region and a second region that have differently arranged holes, and wherein the light that is emitted through the first region has a different brightness than does the light that is emitted through the second region.

31. A method of manufacturing an optical device, comprising:
coating an output face of a downstream converter with a material from which an image mask is formed, wherein the downstream converter has an input face and the output face, and wherein an output surface of a light source is disposed adjacent to the input face of the downstream converter;
removing a portion of the material so as to form the image mask, wherein the image mask is disposed adjacent to the output face of the downstream converter, and wherein the image mask is configured such that picture information is projected as light is emitted by the light source from the output surface, through the downstream converter and through the image mask.

32. The method of claim 31, wherein the portion of the material is removed by etching.

33. The method of claim 31, wherein the portion of the material is removed by laser ablation using a laser beam.

34. The method of claim 33, wherein the portion of the material is removed to form holes in the image mask, and wherein the amplitude of the laser beam is varied so as to form holes of different sizes.

35. The method of claim 34, wherein the holes are arranged uniformly across a region of the image mask.
